(19) United States
(12) Patent Application Publication
(10) Pub. No.: US 2009/0188918 A1
(43) Pub. Date: Jul. 30, 2009

(54) ADJUSTABLE MEASURING DISPENSING CAP

(76) Inventor: Edward S. Robbins, III, Muscle Shoals, AL (US)

Correspondence Address: INDIANAPOLIS OFFICE 27879;BRINKS HOFER GILSON & LIONE, CAPITAL CENTER, SUITE 1100, 201 NORTH ILLINOIS STREET, INDIANAPOLIS, IN, 46204-4220, US

(21) Appl. No.: 12/327,176

(22) Filed: Dec. 3, 2008

Related U.S. Application Data
(60) Provisional application No. 61/024,644, filed on Jan. 30, 2008.

(51) Int. Cl. B65D 51/00; B65D 8/00; B67D 3/00

(52) U.S. Cl. 220/212; 220/600; 222/520

(57) ABSTRACT

An adjustable dispensing cap for a container has a housing having an outwardly extending flange, an insert mounted for rotation within the housing, and a separate collar including a ring having an outer edge, an inwardly projecting flange for contacting a projecting flange portion of the dispensing cap, and an interior surface including coupling elements for coupling the collar and dispensing cap to said container opening. The separate collar can include an overcap integrally formed with the ring and including a rim portion selectively engable with the ring out edge, the overcap having a side wall and an end face coupled to the overcap rim, the overcap being coupled to the ring so that the overcap can be repeatedly moved between a closed position covering the ring and an open position permitting access to the container mouth.

### CROSS-REFERENCE TO RELATED APPLICATIONS

The present application is related to and claims all available benefit from U.S. Provisional Application Ser. No. 61/024,644 filed Jan. 30, 2008.

### BACKGROUND OF THE INVENTION

1. Field of the Invention

The present invention generally relates to caps for containers usable for storage and dispensing of liquids and particulate solids, and extends to caps of the type that are capable of dispensing a stored liquid or particulate solid in a measured amount that may be selected by the user without removal of the cap from the container.

2. Description of the Prior Art

There are presently available a number of caps for containers that may be used to store liquids, such as detergents, and particulate solids. In addition, available caps may be capable of use for dispensing a measured portion of the liquid or particulate solid, by removal of the cap from the container, pouring the desired amount of liquid or particulate solid into the cap while disposed in an inverted position, and then pouring the liquid or particulate solid from the cap. The use of such caps requires that the container be of a size that it can be conveniently tipped or even inverted while full of the usual amount of liquid or particulate solid, which effectively limits the container size to only a few quarts or gallons.

More recently, measuring dispensing caps have been developed that are capable of conveniently dispensing a measured portion of a liquid or particulate solid from a container without removal of the cap from the container, with the volume of material to be dispensed selected by the user to be any volume up to a maximum volume, and simultaneously preventing the remaining stored material from being dispensed or spilled during the dispensing operation. Such caps have the advantage of being used in connection with containers that might be too large for convenient tipping or inversion by the ordinary user. Examples of such caps are to be found in U.S. Pat. Nos. 5,020,699; 6,041,979; and 6,783,031.

The known measuring dispensing caps typically engage a finish portion surrounding an opening into the container through engagement with threads or other cap engaging features. The alignment of the cap engaging features of the finish on all containers of any given model is not necessarily uniform. As a result, the alignment of the measuring dispensing cap is not always at the most desirable orientation, which can cause the desired dispensing operation to be rather awkward, if not impossible. What is needed is a measuring dispensing cap that will accommodate variations in alignment of the cap engaging features on a finish to which the cap is to be secured.

### SUMMARY OF THE INVENTION

A measuring dispensing cap can be adjustably mounted to a container holding a material such as a liquid or particulate solid so that the cap can be aligned by the consumer at any desired position. The cap can include a housing and an insert movable with respect to the housing to capture a measured amount of the material from the container, and then dispense that measured mount when desired. A separate collar can couple the housing to a cap engaging portion of the container surrounding a container opening.

The housing can be formed to include a front surface that can include a tab bore and a dispensing aperture. The housing can include a cylindrical sleeve. The cylindrical sleeve can have a first opening. The housing front surface can be generally domed. The dispensing aperture can include a generally arcuate pouring mouth. The front surface can include a translucent or transparent region. The housing can also define at least one pressure relief passage, which can be included in the front surface. The housing can also include a flange extending radially outward from the cylindrical sleeve. The flange can have a first surface adapted to contact a confronting surface surrounding an opening into a container and a second surface obverse to the first surface.

The separate collar can include a radially inwardly projecting ring adapted to contact the second surface of the radially extending flange. The collar can have an interior surface having coupling elements for coupling the collar and housing to a container opening. The coupling elements can be in the form of an inwardly extending screw thread for cooperative engagement with a similar thread included on a finish portion of the container opening. The coupling elements can also take the form of a bayonet coupling or tang structure for engagement with a suitably formed container finish surrounding the opening.

The insert can be disposed generally within the housing and can have a portion extending through the tab bore. The insert can define a transfer compartment, and include first and second ends. A first end of the insert can be disposed to rotate within an annular slot defined by an end piece of the housing. The insert can further define an inlet orifice proximate to the first end and an outlet orifice proximate to a second end. The insert can include an insert cylindrical surface disposed generally coaxially with the housing cylindrical sleeve. The insert can have a domed portion disposed within the domed portion of the housing. Further, the outlet orifice of the insert can be formed to generally correspond with the dispensing aperture of the housing. The second end of the insert can include a translucent or transparent portion permitting visual determination of a quantity of material within the transfer compartment.

The insert can have at least one pressure relief aperture communicating with the transfer compartment. The number and positions of the pressure relief apertures can be chosen to correspond with the number and position of the pressure relief passages of the housing. At least one pressure relief aperture can be aligned with at least one pressure relief passage as the insert is rotated with respect to the housing, so that air can flow into or out of the transfer compartment. The insert can include a projecting graspable tab disposed to project through the tab bore of the housing. By grasping the tab and applying torque, the insert may be rotated within the housing through a plurality of positions.

In a first position, material present within the interior of the container can be transferred to the transfer compartment. When in the first position, at least one pressure relief aperture can be aligned with at least one pressure relief passage so that air within the transfer compartment can escape. The outlet orifice of the insert can be located so that material transferred into the transfer compartment cannot be dispensed from the container while the insert is in the first position. The insert may thereafter be rotated to a second position where the inlet orifice is disposed within and closed by the housing cylindrical sleeve, and the outlet orifice is generally aligned with the dispensing aperture of the housing. In the second position, material present within the transfer compartment can be dispensed from the cap through the outlet orifice and the dispensing aperture, but material within the container cannot be transferred into the transfer compartment. In the second position, at least one pressure relief aperture is disposed in alignment with at least one pressure relief passage, so that ambient air may enter the transfer chamber. Finally, the insert can be rotated to a third position where none of openings are aligned so that the contents of the container can be sealed.

A measuring dispensing cap of the present invention can also be formed from three pieces including a protective overcap. The pieces can be telescopically received into a nesting relationship that permits the movement of a first piece relative to a second piece to achieve the measuring and dispensing functions of the cap. The cap can have a housing including a tapered sidewall defining a cylindrical chamber having an open first end. The housing can also have an end wall coupled to the housing sidewall that defines a partially closed second end of the chamber. The housing end wall can include an axial opening and a non-axial opening. The housing can also include a flange that protrudes radially outwardly from the housing side wall. The radially protruding flange can include a first surface adapted to contact a confronting surface surrounding an opening into a container and a second surface obverse to the first surface. The housing can also include an aperture in the housing sidewall through which material can flow from the container into the dispensing cap.

The measuring dispensing cap of the present invention can also include an insert telescopically received into open first end of the cylindrical chamber of the housing. The insert preferably has a peripheral wall portion specifically dimensioned to conform to the cylindrical chamber interior surface so as to permit rotation of the insert within the chamber. A first insert end wall coupled to the peripheral wall portion can include a protruding portion extending through the axial opening in the housing end wall. An aperture can be provided in the insert peripheral wall portion for alignment with the housing sidewall aperture to permit the interior of the insert to be filled with material from the container to which the measuring dispensing cap is connected. The first insert can also include a non-axial opening positioned for alignment with the housing non-axial opening only when the insert is suitably positioned with respect to the housing to permit dispensing of any material from within the insert. A second insert end wall can be coupled to the insert peripheral wall portion opposite the insert first insert end wall. The second insert end wall can be integrally molded with the remainder of the insert to minimize assembly. The integral assembly can be in the form of an integral hinge portion that permits the displacement of the second insert end wall from an initial molded position to a closed position coupling the second insert end wall to the perimeter of the insert peripheral wall portion.

The housing can be secured to a container finish with a collar having an inwardly extending ring that can clamp the outwardly protruding flange of the housing to a surface of the finish at a variety of positions to accommodate variations in alignment of the cap engaging features on the finish. The collar can have an interior surface having coupling elements for coupling the collar and housing to a container opening. The coupling elements can be in the form of an inwardly extending screw thread for cooperative engagement with a similar thread included on a finish portion surrounding the container mouth. The coupling elements can also take the form of a bayonet coupling or tang structure for engagement with a suitably formed container mouth. The collar can also include an over-cap that can be coupled to an outer rim of the collar for movement between an open position, permitting material to be dispensed through the housing end wall non-axial opening, and a closed position covering the housing end wall.

The axial opening in the housing end wall can include an inwardly projecting ridge than can engage the insert to retain the insert in a fully nested position, yet permit the insert to be rotated within the housing portion to achieve the filling and dispensing operation of the cap. The protruding axial portion of the insert can include an outwardly projecting rim that can engage the inwardly projecting ridge in the axial opening of the housing end wall. During assembly the cooperative engagement of the projecting rim and ridge may cause an audible sound signifying the completed assembly of the two elements together. Once assembled, the insert can be manually rotated with respect to the housing portion to a first position wherein the insert peripheral wall opening is aligned with the housing sidewall aperture to permit the interior of the insert to be filled with material from the container to which the dispensing cap is connected.

The end walls of the housing and insert can be made sufficiently transparent so that the filling operation can be viewed through the end walls of the housing and insert. When the interior of the insert is filled to a desired level, the insert can be rotated to a second position wherein the non-axial openings in the walls of the insert and housing portion are aligned, thus permitting the contents of the insert to be dispensed. Finally, the insert can be rotated to a third position where neither set of openings is aligned so that the contents of the container can be sealed. A further seal can be achieved by moving the over-cap coupled to the ring into position sealing the dispensing openings.

A measuring dispensing cap of the present invention can also take the form of a housing having a cylindrical wall and radially outwardly protruding flange. The housing can have an end wall adjacent to an inner end of the cylindrical wall including a first opening. A second opening can be provided in the cylindrical wall adjacent to the cylindrical wall outer end. A collar can coupled the flange of the housing to an opening of a container at any desired orientation. The collar can have an inwardly extending ring that can clamp the outwardly protruding flange of the housing to a surface of the container opening at a variety of positions to accommodate variations in the desired direction for the cylindrical wall second opening. The collar can have an interior surface having coupling elements for coupling the collar and housing to a container opening. The coupling elements can be in the form of an inwardly extending screw thread for cooperative engagement with a similar thread included on a finish portion of the container mouth. The coupling elements can also take the form of a bayonet coupling or tang structure for engagement with a suitably formed container.

The measuring dispensing cap can also include a handle portion adapted to surround the outer end of the housing cylindrical wall including the second opening. The handle portion can include a dispensing opening that can be aligned with the second opening of the housing cylindrical wall to permit the dispensing of the contents of container. The handle portion can also include an insert adapted to be received in the housing. The insert can include an outwardly protruding seal adapted to contact the inner surface of the housing cylindrical wall. The insert can include an inner end wall having an opening adapted to be aligned with the first opening of the housing to permit a measured amount of the material contained in the container to flow into the housing. The handle portion can include a transparent or translucent outer end wall permitting the monitoring of the amount of material in the housing.

One feature of the present invention is a collar that can clamp the flange extending outwardly from the housing to a surface of the container opening at a variety of positions to accommodate variations in alignment of the cap dispensing features to permit optimal orientation of the measuring dispensing cap. This feature insures that the dispensing cap can be aligned to be directed as required by the consumer, which may vary depending on the individual consumer thereby avoiding any awkward manipulation of the container itself when dispensing the contents of the container.

Other features and advantages of the present invention will become apparent to those skilled in the art from the following disclosure of preferred embodiments of the present invention exemplifying the best mode of practicing the invention. The following disclosure references the accompanying drawings illustrating the preferred embodiments.

### BRIEF DESCRIPTION OF THE DRAWINGS

FIG. 1 is a side elevation view of a first dispensing cap of the present invention.

FIG. 2 is front elevation view of the dispensing cap shown in FIG. 1, the cap being in a position to permit material present within a container to inter the transfer compartment within cap.

FIG. 3 is a sectional view taken along line 3-3 of FIG. 1 of the housing portion of the dispensing cap.

FIG. 4 is a sectional view of a collar adapted to secure the housing of the dispensing cap of FIGS. 1-3 to a container, not shown.

FIG. 5 is a front elevation view similar to FIG. 1 with the insert having been rotated to permit material present within the transfer compartment to be dispensed through the dispensing outlet.

FIG. 6 is a front elevation view similar to FIGS. 1 and 5 with the insert having been rotated to a sealed position.

FIG. 7 is an elevation view of a unitary ring and overcap of the present invention.

FIG. 8 is a sectional view of the unitary ring and overcap shown in FIG. 7.

FIG. 9 is an exploded sectional view of the unitary ring and overcap shown in FIGS. 7 and 8 in relation to a housing of another dispensing cap of the present invention.

FIG. 10 is a sectional view of an insert designed to be received within the housing shown in FIG. 9.

FIG. 11 is a sectional view of an assembled measuring dispensing cap formed from the portions shown in FIGS. 7-10, the insert being positioned in a sealed position.

FIG. 12 is a front elevation view of the assembled measuring dispensing cap of FIG. 11 attached to a container with the insert being rotated to a dispensing position.

FIG. 13 is a perspective view of another dispensing cap of the present invention.

FIG. 14 is an exploded perspective view of the dispensing cap shown in FIG. 13.

### DESCRIPTION OF PREFERRED EMBODIMENTS

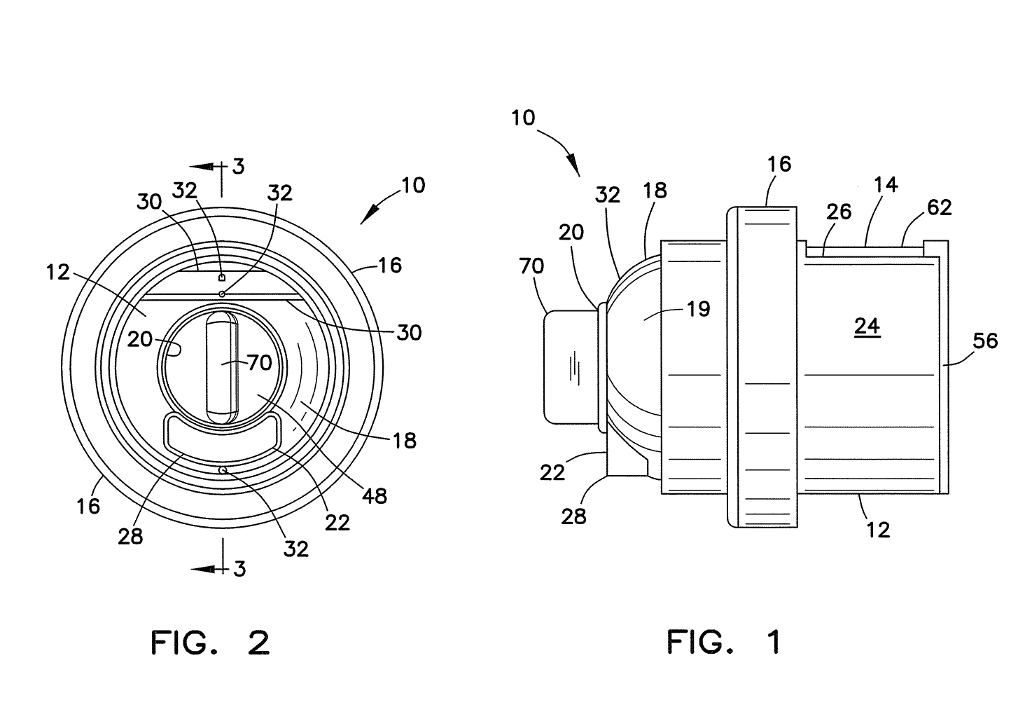

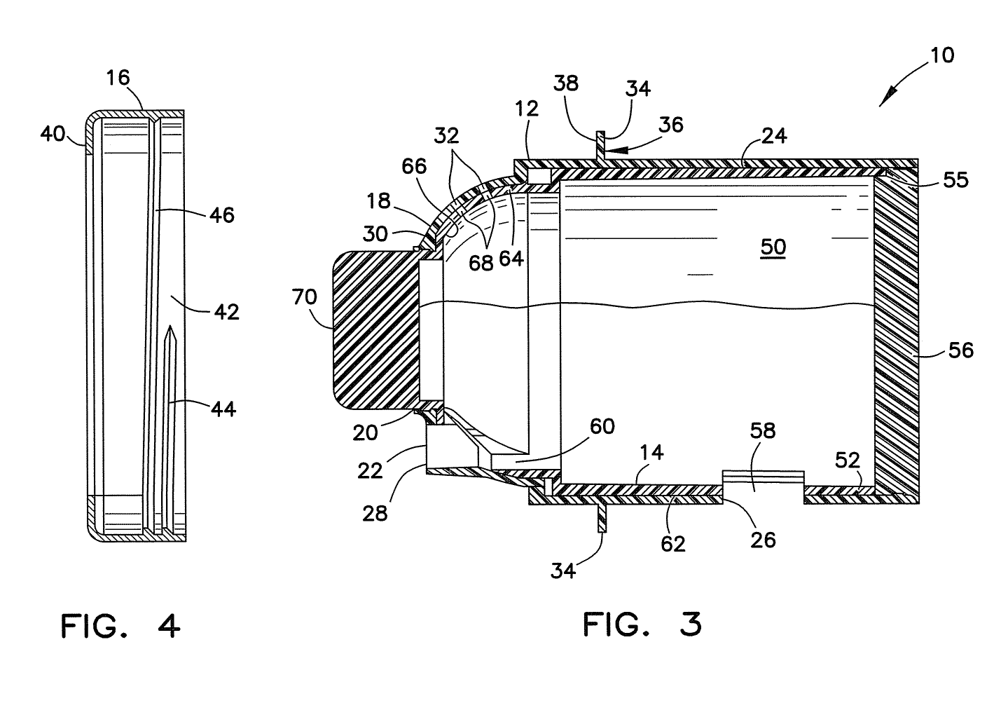

A first dispensing cap 10 is shown in FIGS. 1-6 to include a housing 12, an insert 14, and a collar 16. The housing 12 can be formed to include a front surface 18 that can include a tab bore 20 and a dispensing aperture 22. The housing 12 can include a cylindrical sleeve 24. The cylindrical sleeve 24 can have a first opening 26, which can be variously located around the sleeve 24. The housing front surface 18 can be generally domed as shown, for example, in FIGS. 1 and 3. The dispensing aperture 22 can include a generally arcuate pouring mouth 28. The front surface 18 can include a translucent or transparent region 30. The housing 12 can also define at least one pressure relief passage 32, which can be included in the front surface 18. The housing can also include a flange 34 extending radially outward from the cylindrical sleeve 24. The flange 34, shown in FIG. 3, can have a first surface 36 adapted to contact a confronting surface surrounding an opening into a container, not shown. The flange 34 can have a second surface 38 obverse to the first surface 36.

The separate collar 16 can include a radially inwardly projecting ring 40 adapted to contact the second surface 38 of the radially extending flange 34. The collar 16 can have an interior surface 42 having coupling elements 44 for coupling the collar 16 and housing 12 to a container opening, not shown. The coupling elements 44 can be in the form of an inwardly extending screw thread 46 for cooperative engagement with a similar thread included on a finish portion of the container opening, not shown. The coupling elements can also take the form of a bayonet coupling or tang structure for engagement with a suitably formed container finish surrounding the opening, not shown. The collar 16 can clamp the flange 34 extending outwardly from the housing 12 to a surface of the container opening, not shown, at a variety of positions to accommodate variations in alignment of the dispensing features of the cap 10, detailed below, to permit optimal orientation of the measuring dispensing cap 10. This insures that the dispensing cap 10 can be aligned as required by the consumer to avoid any awkward manipulation of the container when dispensing the container contents.

The insert 14 can be disposed generally within the housing 12 and can have a portion 48 extending through the tab bore 20. The insert 14 can define a transfer compartment 50, and include a first end 52 and a second end 54. The first end 52 of the insert 14 can be disposed to rotate within an annular slot 55 that can be defined at least in part by an end piece 56 of the housing 12. The insert 14 can further define an inlet orifice 58 proximate to the first end 52 and an outlet orifice 60 proximate to a second end 54. The insert 14 can include an insert cylindrical surface 62 disposed generally coaxially with the cylindrical sleeve 24 of the housing 12. The insert 14 can have a domed portion 64 disposed within the domed portion 19 of the housing 12. Further, the outlet orifice 60 of the insert 14 can be formed to generally correspond with the dispensing aperture 22 of the housing 12. The second end 54 of the insert can include a translucent or transparent portion 66 permitting visual determination of a quantity of material within the transfer compartment 50.

The insert 14 can have at least one pressure relief aperture 68 communicating with the transfer compartment 50. The number and positions of the pressure relief apertures 68 can be chosen to correspond with the number and position of the pressure relief passages 32 of the housing 12. At least one pressure relief aperture 68 can be aligned with at least one pressure relief passage 32 as the insert 14 is rotated with respect to the housing 12, so that air can flow into or out of the transfer compartment 50. The insert 14 can include a projecting graspable tab 70 disposed to project through the tab bore 20 of the housing 12. By grasping the tab 70 and applying torque, the insert 14 may be rotated within the housing 12 through a plurality of positions.

In a first position shown in FIGS. 1 and 2, material present within the interior of the container surrounding the dispensing cap 10 can be transferred to the transfer compartment 50. When in the first position, at least one pressure relief aperture 68 can be aligned with at least one pressure relief passage 32 so that air within the transfer compartment 50 can escape as the material surrounding the dispensing cap 10 enters the transfer compartment 50. The outlet orifice 60 of the insert 14 can be located so that material transferred into the transfer compartment 50 cannot be dispensed from the container while the insert 14 is in the first position. The insert 14 may thereafter be rotated to a second position, shown in FIG. 5, where the inlet orifice 58 is disposed within and closed by the cylindrical sleeve 24 of the housing 12, and the outlet orifice 60 is generally aligned with the dispensing aperture 22 of the housing 12. In the second position, material present within the transfer compartment 50 can be dispensed from the cap 10 through the outlet orifice 60 and the dispensing aperture 22, but material within the container cannot be transferred into the transfer compartment 50. In the second position, at least one pressure relief aperture 68 can be disposed in alignment with at least one pressure relief passage 32, so that ambient air may enter the transfer compartment 50 as the material exits through the outlet orifice 60. Finally, the insert 14 can be rotated to a third position, shown for example in FIG. 6, where none of openings, orifices and apertures are aligned so that the contents of the container can be sealed.

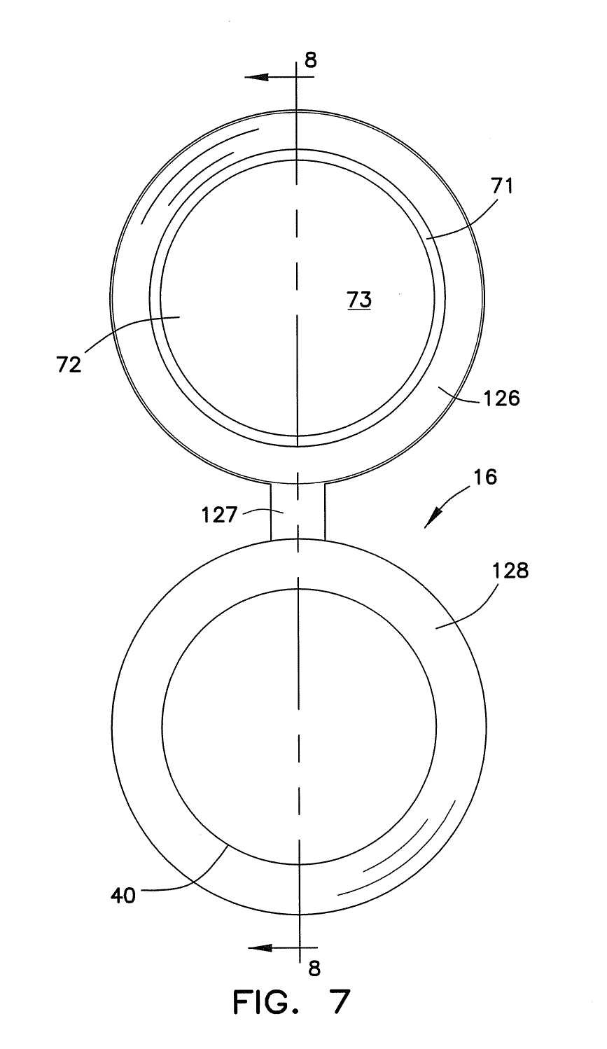

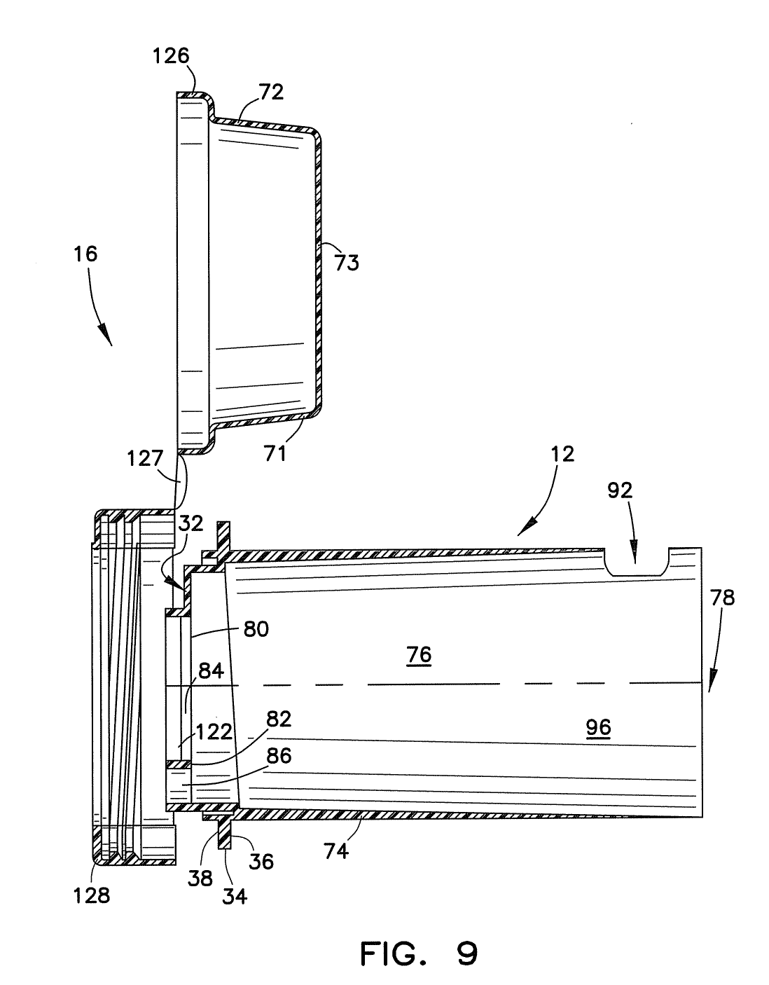

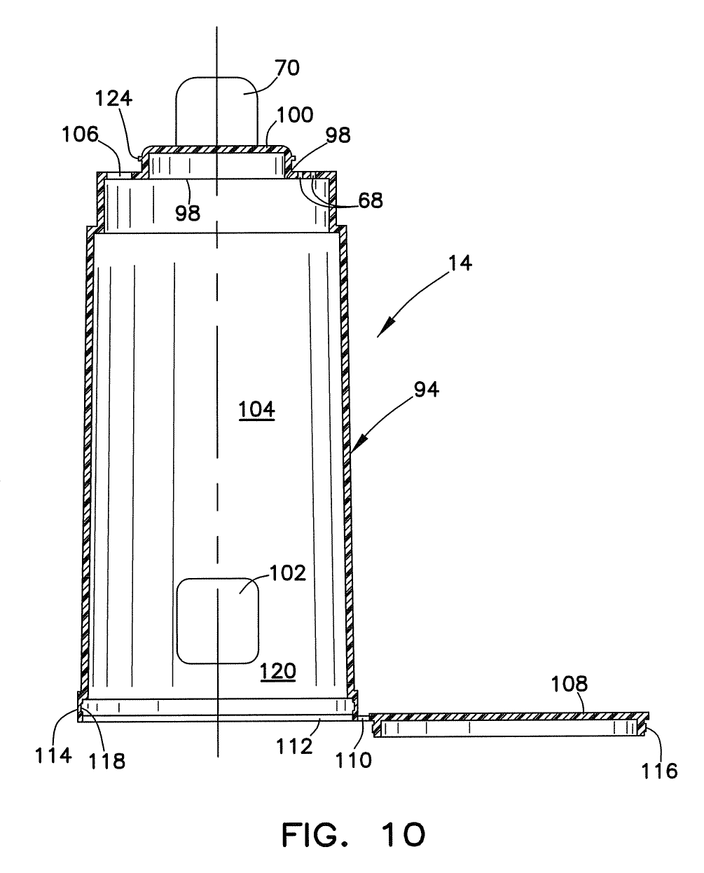

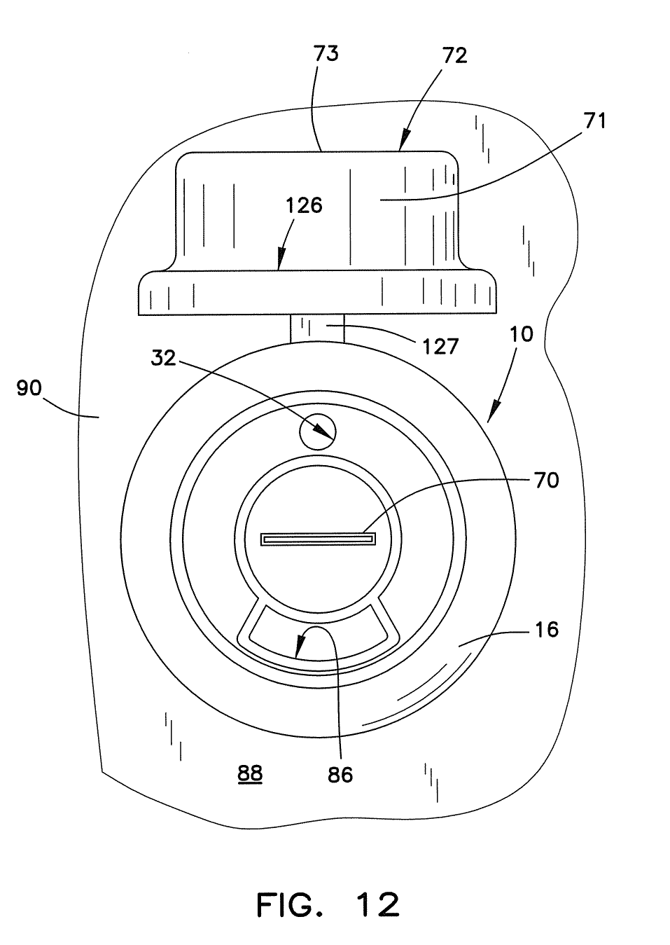

Another dispensing cap 10 is shown in FIGS. 7-12 that can be formed from three pieces; namely a housing 12, an insert 14, and a separate collar 16 including a protective overcap 72. The pieces 12, 14 and 16 can be telescopically received into a nesting relationship, as shown in FIGS. 9 and 11, which permits a suitable orientation of the housing 12 relative to any container and the movement of the insert 14 relative to the housing 12 to achieve the measuring and dispensing functions of the cap 10. The cap 10 can have a housing 12, shown in FIG. 9, including a tapered sidewall 74 defining a cylindrical chamber 76 having an open first end 78. The housing 12 can also have an end wall 80 coupled to the housing sidewall 74 that defines a partially closed second end 82 of the chamber 76. The end wall 80 of the housing 12 can include an axial opening 84 and a non-axial opening 86. The housing 12 can also include a flange 34 that protrudes radially outwardly from the housing sidewall 74. The radially protruding flange 34 can include a first surface 36 adapted to contact a confronting surface 88 surrounding an opening into a container 90, shown in FIG. 12. The flange 34 can have a second surface 38 obverse to the first surface 36. The housing 12 can also include an aperture 92 in the housing sidewall 74 through which material can flow from the container 90 into the dispensing cap 10. The aperture 92 can be situated at any desired location around the sidewall 74 relative to the non-axial dispensing opening 86.

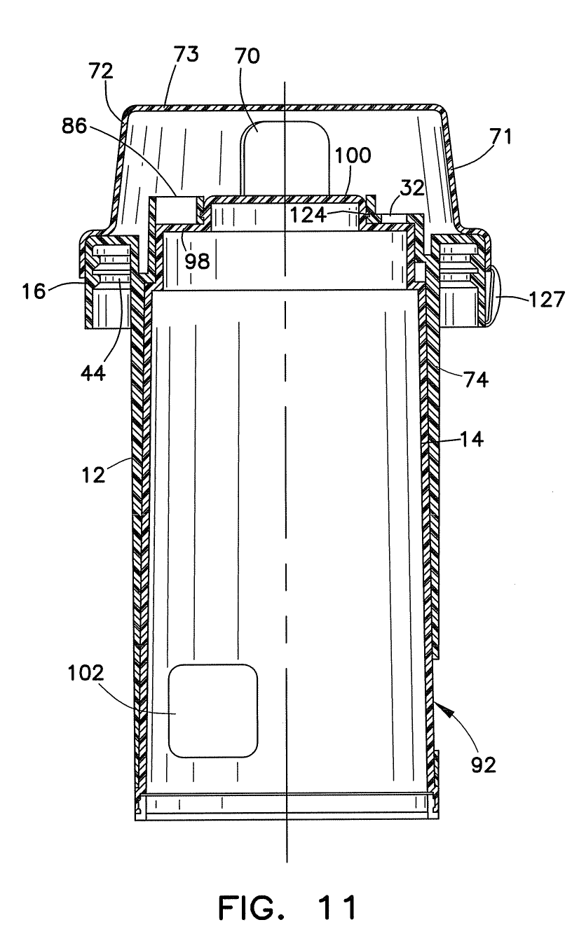

The dispensing cap 10 can also include an insert 14, as shown in FIG. 10, which can be telescopically received into the open first end 78 of the cylindrical chamber 76 of the housing 12. The insert 14 can have a peripheral wall portion 94 specifically dimensioned to conform to the interior surface 96 of the cylindrical chamber 76 so as to permit rotation of the insert 14 within the chamber 76. A first insert end wall 98 coupled to the peripheral wall 94 can include a protruding portion 100 extending through the axial opening 84 in the housing end wall 80. An aperture 102 can be provided in the insert peripheral wall portion 94 for alignment with the aperture 92 of the housing sidewall 74 to permit the interior 104 of the insert 14 to be filled with material from the container 90 to which the dispensing cap 10 is connected. The insert 14 can also include a non-axial opening 106 positioned for alignment with the non-axial opening 86 of the housing 12 only when the insert 14 is suitably positioned with respect to the housing 12 to permit dispensing of any material from the interior 104 of the insert 14.

A second end wall 108 of the insert 14 can be coupled to the peripheral wall portion 94 of the insert 14 at an end opposite the insert first insert end wall 98. The second insert end wall 108 can be integrally molded with the remainder of the insert 14 to minimize assembly. The integral assembly can be achieved by including an integral hinge portion 110 that permits the displacement of the second insert end wall 108 from an initial molded position, shown in FIG. 10, to a closed position, shown in FIG. 11, coupling the second insert end wall 108 to a portion 112 of the perimeter 114 of the insert peripheral wall portion 94. The second insert end wall 108 can include a ridge 116 sized to be received in a groove 118 present on the interior surface 120 of the peripheral wall portion 94.

The axial opening 84 in the housing end wall 80 can include an inwardly projecting ridge 122 than can engage the insert 14 to retain the insert in a fully nested position, as shown in FIG. 11, yet permit the insert 14 to be rotated within the housing 12 to achieve the filling and dispensing operation of the cap 10. The protruding axial portion 100 of the insert 14 can include an outwardly projecting rim 124 that can engage the inwardly projecting ridge 122 in the axial opening 84 of the housing end wall 80. During assembly, the cooperative engagement of the projecting rim 124 and ridge 122 may cause an audible sound signifying the completed assembly of the two elements 12 and 14 together. Once assembled, the insert 14 can be manually rotated with respect to the housing 12 to a first position wherein the insert peripheral wall opening 102 is aligned with the housing sidewall aperture 92 to permit the interior 104 of the insert 14 to be filled with material from the container 90 to which the dispensing cap 10 is connected.

The end wall 80 of the housing 12 and the end wall 98 of the insert 14 can be made sufficiently transparent so that the filling operation can be viewed through one or more of the end walls. When the interior 104 of the insert 14 is filled to a desired level, the insert 14 can be rotated, by applying a torque to tab 70, to a second position where the non-axial opening 86 of the housing end wall 80 and the non-axial opening 106 of the insert end wall 98 are aligned, thus permitting the contents of the insert 14 to be dispensed. Finally, the insert 14 can be rotated to a third position, shown for example in FIG. 11, where neither set of openings is aligned so that the contents of the container 90 can be sealed.

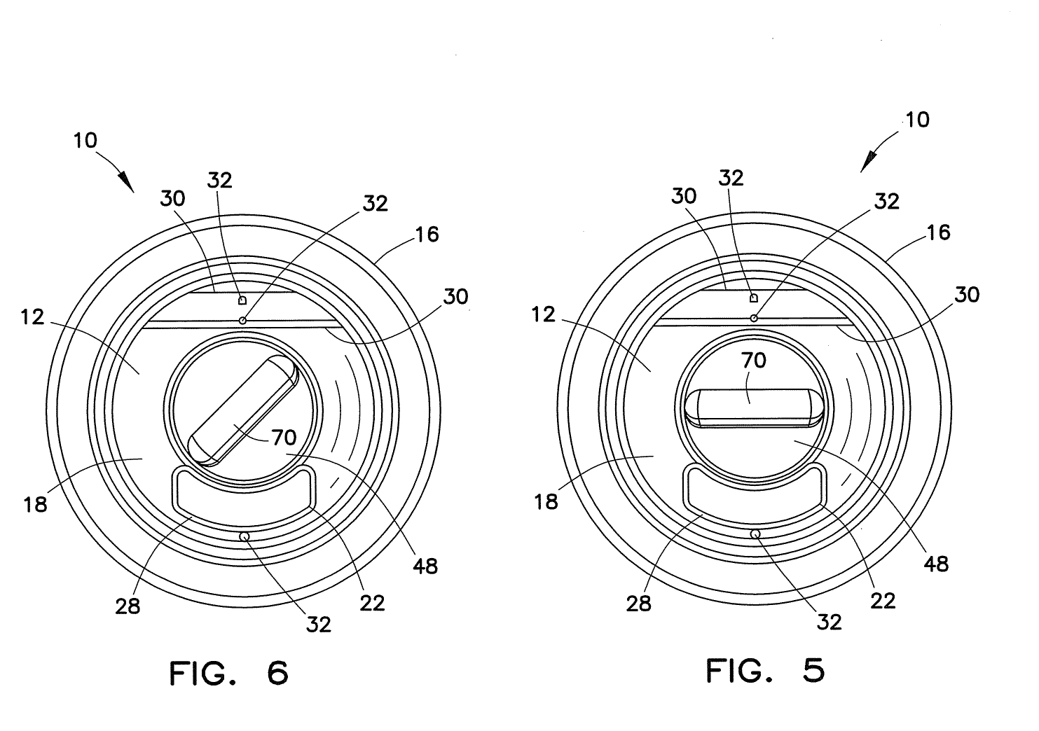

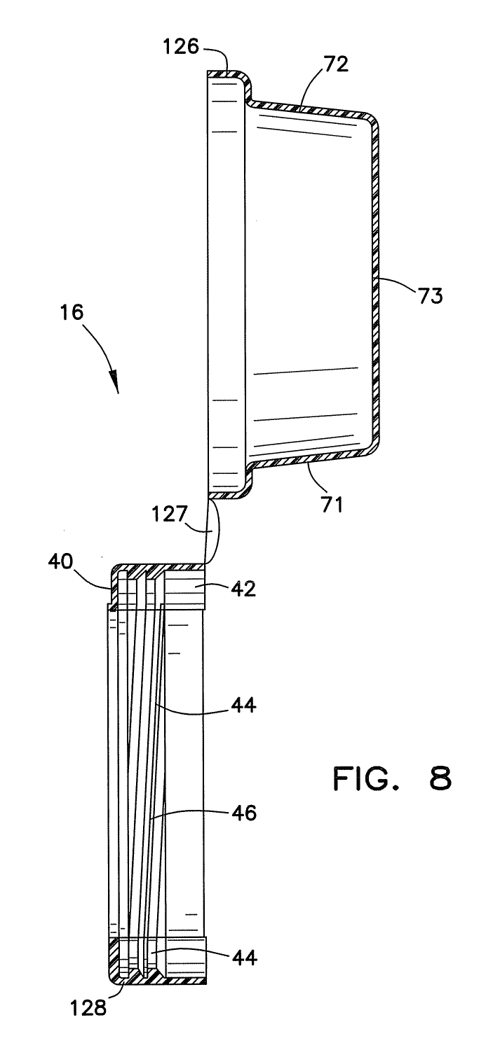

The housing 12 shown in FIGS. 9 and 11 can be secured to finish on the container 90 with a collar 16 as shown in FIG. 4. The housing 12 shown in FIGS. 9 and 11 can also be secured to finish on the container 90 with a collar 16 as shown in FIGS. 7-9, 11 and 12. Both collars 16 can have an inwardly extending ring 40 that can clamp the outwardly protruding flange 34 of the housing 12 to a surface of the container finish at a variety of positions to accommodate variations in alignment of the engaging features of the cap 10 on the finish. Both collars 16 can have an interior surface 42 having coupling elements 44 for coupling the collar 16 and housing 12 to a container 90. The coupling elements 44 can be in the form of an inwardly extending screw thread 46 for cooperative engagement with a similar thread included on a finish portion surrounding the container mouth, not shown. The coupling elements 44 can also take the form of a bayonet coupling or tang structure for engagement with a suitably formed container mouth. The collar 16 shown in FIGS. 7-9, 11 and 12 can also include an over-cap 72 having a rim 126 that can be coupled to an outer rim 128 of the collar 16. The over-cap 72 can be joined to the collar 16 by a flexible hinge 127 for movement between an open position, shown in FIG. 8, permitting material to be dispensed from the container 90, and a closed position, shown in FIG. 11, covering the housing end wall. The over-cap 72 can have a sidewall 71 that positions the end wall 73 sufficiently far from rim 126 to ensure that the tab 70 can be included within the over-cap 72 when in the closed position. By moving the over-cap 72 to the closed position, a further seal can be achieved above that achieved by merely moving the insert 14 so that the various openings in the insert 14 and housing 12 are in a non-aligned position. The collar 16 shown in FIGS. 7-9, 11 and 12 can also be used in conjunction with the housing 12 and insert 14 shown in FIGS. 1-3, 5 and 6.

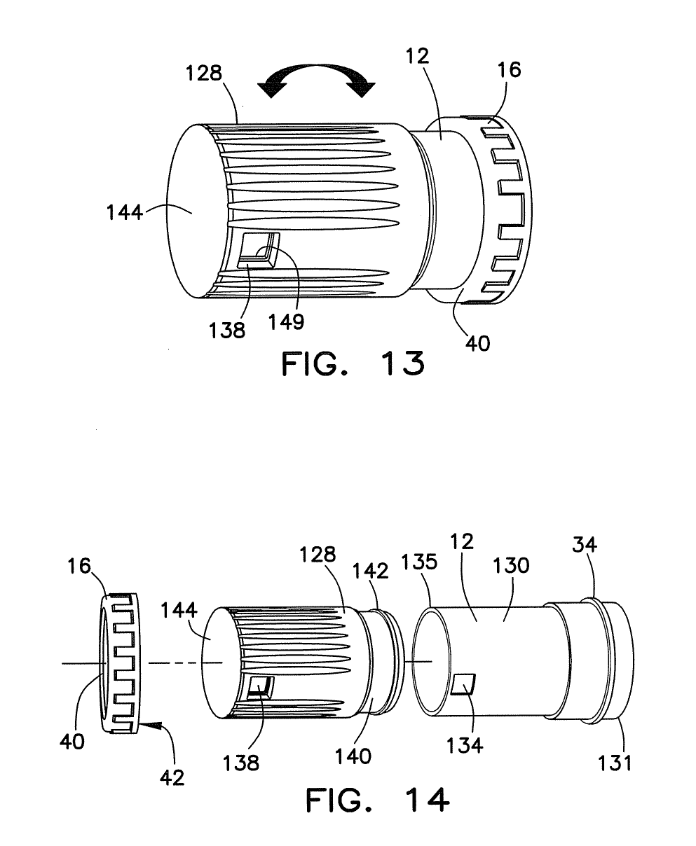

Another dispensing cap 10 is shown in FIGS. 13 and 14 that can include a housing 12 having a cylindrical wall 130 and radially outwardly protruding flange 34. The housing 12 can have an inner end wall, not shown, adjacent to an inner end 131 of the cylindrical wall 130 including a first opening, not shown. A second opening 134 can be provided in the cylindrical wall 130 adjacent to the cylindrical wall outer end 135. A collar 16, similar to the collar 16 shown in FIG. 4, can couple the flange 34 of the housing 12 to an opening of a container at any desired orientation. The collar 16 can have an inwardly extending ring 40 that can clamp the outwardly protruding flange 34 of the housing 12 to a surface of the container opening at a variety of positions to accommodate variations in the desired direction for the cylindrical wall second opening 134. The collar 16 can have an interior surface 42 having coupling elements for coupling the collar 16 and housing 12 to a container opening. As disclosed in conjunction with FIG. 4, the coupling elements 44 can be in the form of an inwardly extending screw thread for cooperative engagement with a similar thread included on a finish portion of the container mouth. The coupling elements 44 can also take the form of a bayonet coupling or tang structure for engagement with a suitably formed container.

A handle portion 128 can be adapted to surround the outer end 135 of the cylindrical wall 130 of housing 12. The handle portion 128 can have a dispensing opening 138 that can be aligned with the opening 134 of the housing cylindrical wall 130 to permit the dispensing of the contents of a container to which the cap is secured. The handle portion 128 can also include an insert portion 140 adapted to be received in the housing 12. The insert portion 140 can include an outwardly protruding seal 142 adapted to contact an inner surface of the housing cylindrical wall 130. The insert 140 can include an inner end wall, not shown, having an opening adapted to be aligned with an opening of the housing inner end wall leading to the interior of the container to permit a measured amount of the material contained in the container to flow into the housing 12. The handle portion 128 can include a transparent or translucent outer end wall 144 permitting the monitoring of the amount of material in the housing 12.

From the forgoing description of the structure and operation of a preferred embodiment of the present invention, it will be apparent to those skilled in the art that the present invention is susceptible to numerous modifications and embodiments within the ability of those skilled in the art and without exercise of the inventive facility. Accordingly, the scope of the present invention is defined as set forth of the following claims.

1. A cap for dispensing material from a container comprising:
a housing having a sidewall defining a cylindrical chamber and a flange extending outward from the housing sidewall,
an insert at least partially received within the cylindrical chamber, the insert and housing defining an interior volume, each of the insert and housing having a first passage the when aligned allows material to pass into the interior volume from a container to which the cap may be attached, each of the insert and housing having a second passage that when aligned allows material to be dispensed from the interior volume, the first and second passage sets being aligned such that the first and second passages cannot be simultaneously aligned to allow direct dispensing of material from the container, and
a separate collar coupling the housing flange to the container, the collar and housing flange being adjustable with respect to the container to permit the cylindrical chamber of the housing to be positioned at any selected orientation relative to the container to facilitate a controlled dispensing of material from the container.

2. The dispensing cap of claim 1, wherein the housing further comprises end wall coupled to the housing sidewall and defining a partially closed end of the chamber, the housing end wall including an axial opening and a non-axial opening, the non-axial opening defining said housing second passage, the housing including an aperture in the housing sidewall defining the housing first passage.

3. The dispensing cap of claim 2, wherein the further comprises a peripheral wall portion specifically dimensioned to conform to the cylindrical housing interior surface so as to permit rotation of the insert within the housing, a first insert end wall coupled to the peripheral wall portion and including a protruding portion extending through the axial opening in the housing end wall, the first insert end wall also including a non-axial opening defining the insert second passage positioned for alignment with the housing non-axial opening only when the insert is suitably positioned with respect to the housing, and an aperture in the insert peripheral wall portion defining the insert first passage for alignment with the housing sidewall aperture.

4. The dispensing cap of claim 3, further comprising a second insert end wall coupled to the insert peripheral wall portion opposite the insert first insert end wall.

5. The dispensing cap of claim 1, further comprising an over-cap coupled to the separate collar for movement between an open position, permitting material to be dispensed through the housing end wall, and a closed position covering the housing end wall.

6. The dispensing cap of claim 5, further comprising a unitary hinge coupling the over-cap to the collar.

7. The dispensing cap of claim 2, wherein the axial opening in the housing end wall includes a ridge and the protruding portion of the insert includes a rim engaging the housing end wall ridge.

8. A dispensing cap for dispensing material from a container comprising:
a housing having a sidewall including an aperture and defining a cylindrical chamber having an open first end, an end wall coupled to the housing sidewall and defining a partially closed second end of the chamber, the housing end wall including an axial opening and a non-axial opening, a protruding flange portion extending outward from the housing sidewall and adapted for attachment to a mouth of said container opening into the container interior;
an insert received into open first end of the cylindrical chamber, the insert having a compartment defined by a peripheral wall portion specifically dimensioned to conform to the cylindrical housing interior surface so as to permit rotation of the insert within the housing, a first insert end wall coupled to the peripheral wall portion and including a protruding portion extending through the axial opening in the housing end wall for manual orientation of the insert with respect to the housing, the insert peripheral wall portion including an aperture into the compartment for alignment with the housing sidewall aperture when the insert is positioned at a first position with respect to the housing, the insert first end wall also including a non-axial opening from the compartment located for alignment with the housing non-axial opening only when the insert is positioned at a second position with respect to the housing; and
a separate collar coupling the housing flange to the container, the collar and housing flange being adjustable with respect to the container to permit the cylindrical chamber of the housing to be positioned at any selected orientation relative to the container to facilitate a controlled dispensing of material from the container.

9. The dispensing cap of claim 8, wherein the separate collar further comprises an over-cap coupled to an edge of the collar for movement between an open position, permitting material to be dispensed through the housing end wall non-axial opening, and a closed position covering the housing end wall.

10. The dispensing cap of claim 8, further comprising a hinge coupling the over-cap to the housing flange portion.

11. The dispensing cap of claim 8, wherein the collar includes an interior surface including coupling elements for coupling the collar and housing to said container opening.

12. The dispensing cap of claim 8, wherein the axial opening in the housing end wall includes a ridge and the protruding portion of the insert includes a rim engaging the housing end wall ridge.

13. The dispensing cap of claim 8, further comprising a second insert end wall at an end of the insert opposite said insert end wall, and a hinge portion coupling the second insert end wall to the insert peripheral wall portion.

14. A dispensing cap for dispensing material from a container comprising:
a housing having a sidewall including an aperture and defining a cylindrical chamber having an open first end, an end wall coupled to the housing sidewall and defining a partially closed second end of the chamber, the housing end wall including an opening, a protruding flange portion extending outward from the housing sidewall and adapted for attachment to a mouth of said container opening into the container interior;
an insert received into open first end of the cylindrical chamber, the insert having a compartment defined by a peripheral wall portion specifically dimensioned to be received within the cylindrical housing interior surface so as to permit rotation of the insert within the housing, a first insert end wall coupled to the peripheral wall portion and including a handle portion extending around the exterior of the housing sidewall for manual orientation of the insert with respect to the housing, the insert peripheral wall portion including an aperture into the compartment for alignment with the housing sidewall aperture when the insert is positioned at a first position with respect to the housing; and
a separate collar coupling the housing flange to the container, the collar and housing flange being adjustable with respect to the container to permit the cylindrical chamber of the housing to be positioned at any selected orientation relative to the container to facilitate a controlled dispensing of material from the container.

15. The dispensing cap of claim 14, wherein the insert further comprises a second end wall, the insert second end wall including a non-axial opening from the container into the compartment, the non-axial opening being located for alignment with the housing end wall opening only when the insert is positioned at a second position with respect to the housing.

16. The dispensing cap of claim 14, wherein the collar comprises an interior surface including coupling elements for coupling the collar and housing to said container opening.

17. The dispensing cap of claim 14, wherein the insert includes a seal portion extending outwardly from the insert peripheral wall portion to contact the interior surface of the housing sidewall.

18. A collar for use in coupling a dispensing cap to the mouth surrounding on opening out of a container, the collar comprising:
a ring having an outer edge, an inward projection for contacting a dispensing cap, and an interior surface including coupling elements for coupling the collar and dispensing cap to said container opening; and
an overcap integrally formed with the ring and including a rim portion selectively engageable with the ring out edge, the overcap having a side wall and an end face coupled to the overcap rim, the overcap being coupled to the ring so that the overcap can be repeatedly moved between a closed position covering the ring and an open position permitting access to the container opening.

19. The collar of claim 18, wherein the ring inward projection comprises a radially inwardly projecting flange for contacting an axially exterior surface of the dispensing cap.

20. The collar of claim 18, wherein the overcap sidewall is coupled to an edge of the ring axially remote from the ring inward projection.

21. The collar of claim 18, further comprising a seal coupled to the overcap rim portion that in the closed position can contact the ring outer edge to provide a second seal for the contents of the container.
